(19) United States
(12) Patent Application Publication
(10) Pub. No.: US 2009/0140977 A1
(43) Pub. Date: Jun. 4, 2009

(54) Common User Interface Structure

(75) Inventor: Ronald A. Morris, San Francisco, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/948,696

(22) Filed: Nov. 30, 2007

(51) Int. Cl. G09G 5/00

(52) U.S. Cl. 345/156

(57) ABSTRACT

A common user interface structure is described. In embodiment(s), a common user interface structure includes proportional geometry variables that can be adjusted such that the common user interface structure is scaled for display on media devices that each have different sized display screens. The common user interface structure includes a dimension control variable from which the proportional geometry variables are derived to scale the common user interface structure for display. The common user interface structure can also include menu item regions that include selectable content links to initiate rendering media content, and the menu item regions are scaled for display in the common user interface structure when the proportional geometry variables are adjusted.

### BACKGROUND

Various media devices, such as televisions, personal media players, mobile phones, portable video games, computer devices, and the like can all have the capability to acquire and playback or render movies, television programs, photos, and music from various private and public networks, as well as from proprietary marketplaces. It is increasingly commonplace to find more television video content, music videos, and images that can be viewed on almost any media device that has a display screen. Further, it is quite likely that one person may own several of the various media devices.

Having a variety of different media devices, however, can make it difficult for a user to navigate, find, and play or render the different types of media content because most of the different media devices on the market today have a unique interface. A single user of multiple devices, therefore, must learn a new interface for each new device to be able to playback the same movie, view the same photographs, or listen to the same music on the different media devices. For some users, it can be difficult to switch between the many different devices and the different user interfaces.

### SUMMARY

This summary is provided to introduce simplified concepts of a common user interface structure. The simplified concepts are further described below in the Detailed Description. This summary is not intended to identify essential features of the claimed subject matter, nor is it intended for use in determining the scope of the claimed subject matter.

In embodiment(s), a common user interface structure includes proportional geometry variables that can be adjusted such that the common user interface structure is scaled for display on media devices that each have different sized display screens. The common user interface structure includes a dimension control variable from which the proportional geometry variables are derived to scale the common user interface structure for display. The common user interface structure can also include menu item regions that include selectable content links to initiate rendering media content, and the menu item regions are scaled for display in the common user interface structure when the proportional geometry variables are adjusted.

In other embodiment(s) of a common user interface structure, the dimension control variable can be the display height of a media device display screen, and the proportional geometry variables can be adjusted based on the display height such that the common user interface structure is scaled for display on the media device display screen. Alternatively, the dimension control variable can be a display width of the media device display screen, and the proportional geometry variables can be adjusted based on the display width such that the common user interface structure is scaled for display on the media device display screen. Additionally, the common user interface structure can include a navigation control that is selectable to position the navigation control proximate a menu item region to indicate that a selectable content link in the menu item region can be selected to initiate rendering the media content.

### BRIEF DESCRIPTION OF THE DRAWINGS

Embodiments of a common user interface structure are described with reference to the following drawings. The same numbers are used throughout the drawings to reference like features and components:

FIG. 1 illustrates an example embodiment of a common user interface structure implemented for display on various devices.

FIG. 2 illustrates an example system in which embodiments of a common user interface structure can be implemented.

FIG. 3 illustrates example method(s) of a common user interface structure in accordance with one or more embodiments.

FIG. 4 illustrates example method(s) of a common user interface structure in accordance with one or more embodiments.

FIG. 5 illustrates various components of an example device which can implement embodiments of a common user interface structure.

### DETAILED DESCRIPTION

Embodiments of a common user interface structure provide a single user interface that can be scaled for display on any media device which, when implemented, provides a common user interface experience (also referred to as a common “user experience”) across all of the media devices. This simplifies the user experience for users that have multiple devices for media content, such as movies, videos, music, and photos. The common user interface structure can be scaled for display on any of various media devices, such as a personal media player, a display device for a television client device, a portable communication device (e.g., a cellular phone, PDA, and/or combination media player), a computing-based device such as a desktop computer or portable computer, and/or as any other type of media device. In addition to a common user experience, a common user interface structure provides a seamless transition, such as when a user switches between the various media devices to playback or render the same media content.

While features and concepts of the described systems and methods for a common user interface structure can be implemented in any number of different environments, systems, and/or various configurations, embodiments of a common user interface structure are described in the context of the following example systems and environments.

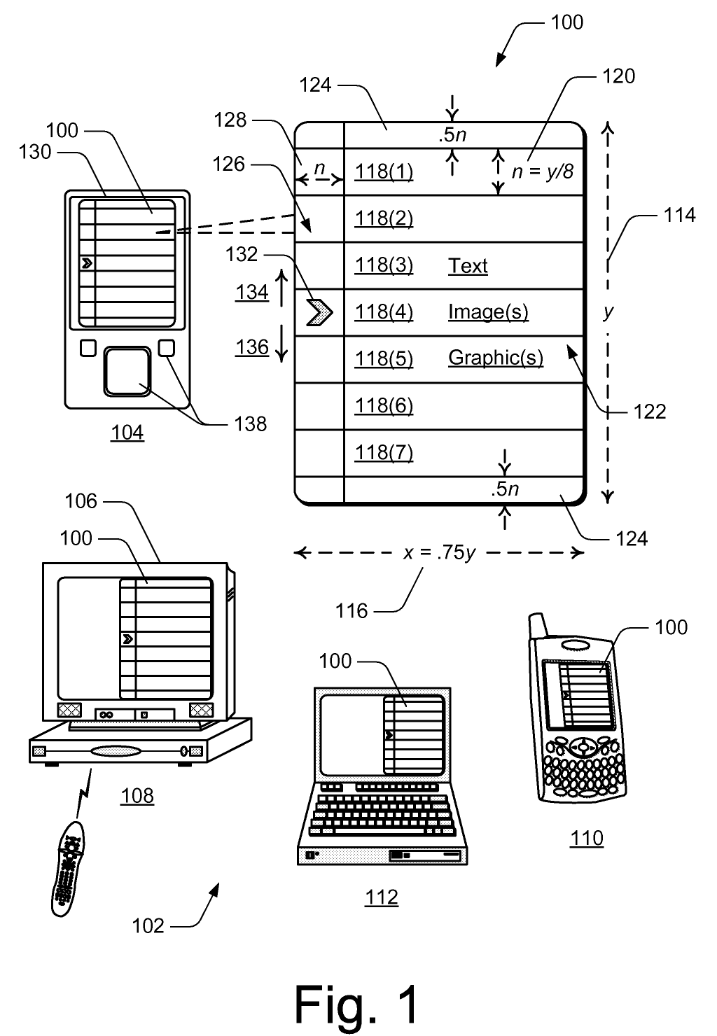

FIG. 1 illustrates an example embodiment of a common user interface structure 100 which can be implemented for display on various media devices 102. The common user interface structure 100 is a single user interface that can be scaled for display on any media device which, when implemented, provides a common user experience across all of the media devices. This simplifies the user experience for users that have multiple devices, such as a video, music, and/or photo media device 104 (e.g., a personal media player).

The common user interface structure 100 can be scaled for display on any of the media device 104, a display device 106 for a television client device 108, a portable communication device 110 (e.g., a cellular phone, PDA, and/or combination media player), and a computing-based device 112, such as a desktop computer, a portable computer, an appliance device, and/or as any other type of media device. The common user interface structure 100 provides a common user experience and a seamless transition, such as when a user switches between the various media devices 102 to request the same media content. As referred to throughout, the “media content” (and/or recorded media content) can include any type of audio, video, and/or image media content received from any type of media content source.

The common user interface structure 100 is implemented with proportional geometry variables that can be adjusted to scale the common user interface structure 100 for display on any of the media devices 102. In an embodiment, the common user interface structure 100 includes a display height variable “y” at 114 which is a dimension control variable from which the other proportional geometry variables can be derived. For example, the common user interface structure 100 includes a display width variable “x” at 116 which is defined as three-fourths of the display height variable “y” (i.e., “x=0.75y”). In an alternate embodiment, the display width variable “x” at 116 can be the dimension control variable from which the other proportional geometry variables can be derived. For example, the display height variable “y” at 114 can be defined as four-thirds of the display width variable “x” (i.e., “y=4x/3”).

The common user interface structure 100 also includes menu item regions 118(1-7) that each have a region height variable “n” at 120 which is defined as one-eighth of the display height variable “y” (i.e., “n=y/8” or “n=0.125y”). Any of the menu item regions 118 can be implemented to display any type of text, images, graphics, and/or data as user-selectable content links 122. For example, menu item region 118(3) may include the text of a movie title, menu item region 118(4) may include photo images, and menu item region 118(5) may include the artwork for a music compilation. In an embodiment, any of the music artwork, photo images, and text of a movie title can be a user-selectable content link 122 that, when selected, initiates the media device to playback or render the media content, such as for listening to the music, watching the movie, or viewing the photos.

The common user interface structure 100 also includes two boundary regions 124 that each have a boundary region height defined as one-half of the region height variable “n” (i.e., “n/2” or “0.5n”). In this example, the boundary regions 124 are shown to border the top and bottom of the menu item regions 118(1-7). In addition, the common user interface structure 100 includes a navigation control region 126 that, in this example, is shown as a vertical column which intersects each of the menu item regions 118(1-7). The navigation control region 126 has a region width variable of “n” at 128 (i.e., the width of the navigation control region 126 is defined by the height of the menu item regions 118(1-7)).

The common user interface structure 100 can be generated for display on any of the media devices 102 when the proportional geometry variables are scaled for the different sized display screens of the various media devices 102. For example, the common user interface structure 100 can be generated for display on a display screen 130 of media device 104 which may have a vertical screen dimension of four inches. The common user interface displayed on media device 104 would then have a display height of four inches (i.e., display height variable “y” at 114), a display width of three inches (i.e., “x=0.75y” at 116), menu item regions 118(1-7) each having a display height of one-half an inch (i.e., “n=y/8” at 120), boundary regions 124 each having a display height of one-quarter of an inch (i.e., “0.5n”), and a navigation control region 126 having a display width of one-half an inch (i.e., “n” at 128).

The proportional geometry variables for the common user interface structure 100 can be similarly scaled for any media device having a small display screen, such as media device 104 and the portable communication device 110, or can be scaled for any media device having a larger display screen, such as display device 106 for television client device 108 and the computing-based device 112. It is contemplated that the terms “small” and “larger” when used to describe the size of a display screen on a media device 102 are relative simply to illustrate that the proportional geometry variables for the common user interface structure 100 can be scaled for any sized display screen of the various media devices 102.

In the example common user interface structure 100, the navigation control region 126 includes a navigation control 132 that can be selected and moved (or otherwise “navigated”) in a first direction 134 and/or in a second direction 136 to position the navigation control 132 within a menu item region to indicate that the text, image, graphic, or data selectable content link 122 in a menu item region is selectable. For example, a user of media device 104 can enter a navigation input, such as via a selectable control 138 on the media device, to initiate moving the navigation control 132 up or towards a top of the common user interface structure 100 (i.e., in the first direction 134), and/or a navigation input or selection can be initiated to move the navigation control 132 down or towards a bottom of the common user interface structure 100 (i.e., in the second direction 136). In an alternate implementation, the common user interface structure 100 can include any type of focus or indication (e.g., a highlight, a pointer, an emphasis, etc.) that can be positioned near, on, over, around, or otherwise proximate a selectable content link 122 in a menu item region 118 to indicate that the text, image, graphic, or data content link is selectable.

The depiction of the common user interface structure 100 is merely exemplary to illustrate one embodiment of a common user interface. In practice, the boundaries (e.g., lines or distinctive edges) of the menu item regions 118(1-7), the boundary regions 124, and/or the navigation control region 126 may not appear in a display of the common user interface structure 100 on a media device 102. Further, the common user interface structure 100 is only shown to have the seven menu item regions 118(1-7). In an embodiment, however, the menu item regions scroll across the common user interface structure 100 on a display screen as navigation inputs are received to move the navigation control 132 in either the first direction 134 and/or the second direction 136. For example, additional text, image, graphic, and/or data selectable content links 122 will continue to be displayed in sequence in other menu item regions in an event that the navigation control 132 is moved in the second direction 136 past the menu item region 118(7).

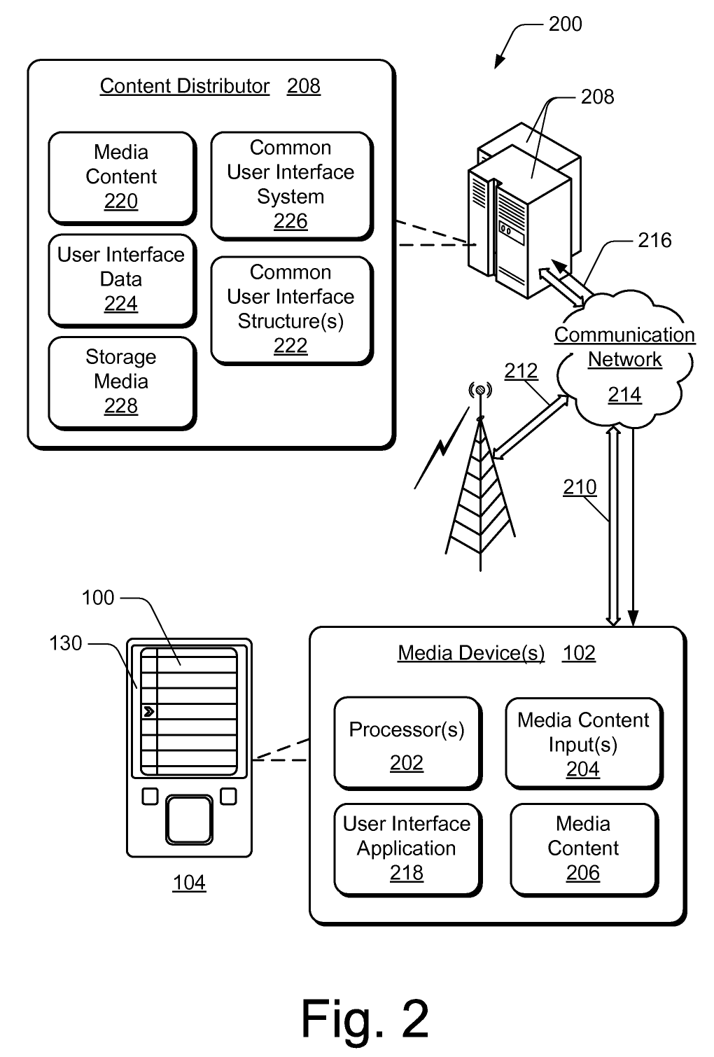

FIG. 2 illustrates an example system 200 in which various embodiments of a common user interface structure can be implemented. In this example, system 200 includes a component representation of the various media devices 102, such as media device 104 (e.g., a personal media player) that includes display screen 130. The media device 102 can be implemented as any one or combination of a television client device, an appliance device, a gaming console, a portable communication device, a computing-based device, and/or as any other type of media device that may be implemented to playback or render any type of audio, video, and/or image media content received from any type of media content source.

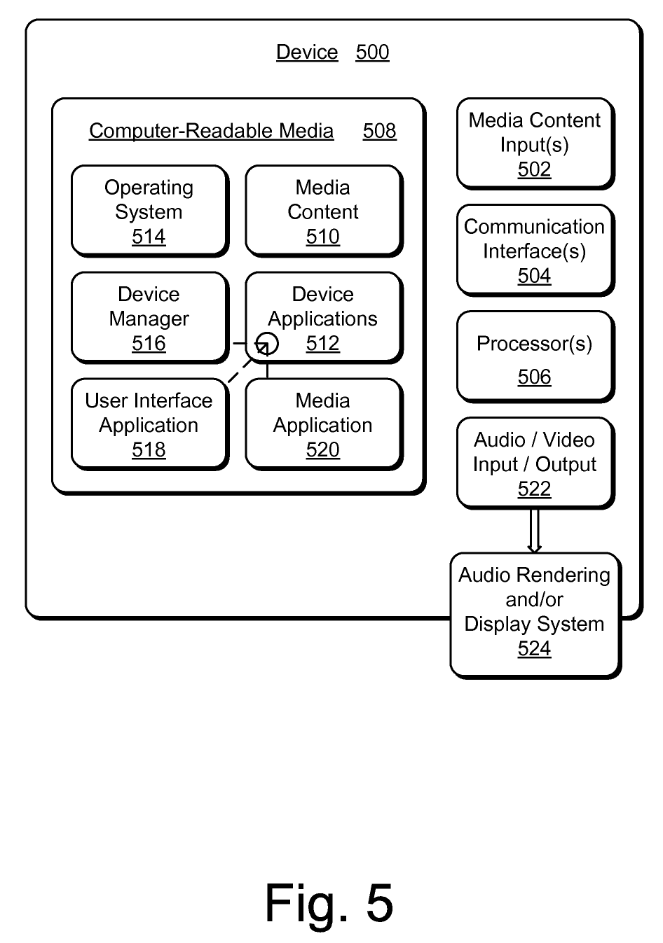

In various embodiments, the media devices 102 can be implemented with any number and combination of differing components as further described with reference to the example device shown in FIG. 5. Any of the various media devices 102 may also be associated with a user or viewer (i.e., a person) and/or an entity that operates the device such that a “device” describes logical devices that may include users, software, and/or other components.

In the example system 200, media device 102 includes one or more processors 202 (e.g., any of microprocessors, controllers, and the like), media content inputs 204, and media content 206 (e.g., any of received media content, media content that is being received, user interface data, common user interface structures, etc.). The media content inputs 204 can include any type of communication interfaces and/or data inputs, such as wireless, broadcast, and/or over-the-air inputs via which the media content 206 is received. In addition, media device 102 can receive user interface data and any other type of audio, video, and/or image media content from any one or more content distributors 208 via the media content inputs 204.

Media device 102 can be configured for communication with the various content distributor(s) 208 via an IP-based network 210, a wireless network 212, and/or a communication network 214. The IP-based network 210 and the wireless network 212 can be implemented as part of the communication network 214 that facilitates media content distribution and data communication between the content distributor(s) 208 and any number of media devices, such as media device 102 and media device 104. The communication network 214 can be implemented as part of a media content distribution system using any type of network topology and/or communication protocol, and can be represented or otherwise implemented as a combination of two or more networks.

Media device 102 can also communicate with any number of the content distributors 208 via a two-way data communication link 216 of the communication network 214. It is contemplated that any one or more of the arrowed communication link 216 and network 210, along with communication network 214, facilitate two-way data communication, such as from media device 102 to a content distributor 208 and vice-versa. The media device 102 can include a device manager (e.g., a control application, software application, etc.) to implement various embodiments and/or features of a common user interface structure. The device manager can be implemented to monitor and/or receive selectable inputs (e.g., viewer selections, navigation inputs, etc.).

Media device 102 can also include a user interface application 218 which can be implemented as computer-executable instructions and executed by the processor(s) 202 to implement various embodiments and/or features of a common user interface structure. In an embodiment, the user interface application 218 can be implemented to generate the common user interface structure 100 for display on media device 104. In another embodiment, the user interface application 218 can be implemented to receive and process common user interface structure data to generate the common user interface structure 100 for display on media device 104. Although the user interface application 218 is illustrated and described as a single application (e.g., as an independent component of media device 102), the user interface application 218 can be implemented as several component applications or modules distributed to implement various embodiments of a common user interface structure.

A content distributor 208 can distribute media content 220, common user interface structures 222, and/or user interface data 224 to any number of the various media devices 102 via the distribution and communication networks. The content distributor 208 can also include various components to implement embodiments of a common user interface structure, such as a common user interface system 226 which can be implemented to generate and manage the common user interface structures 222 and/or the user interface data 224 for display in a common user interface structure.

In an embodiment, the common user interface system 226 can be implemented to communicate or otherwise provide a common user interface structure 222 to media device 102 for display as the common user interface structure 100. Rather than the media device 102 being implemented to process and generate the common user interface structure 100 for display, the common user interface system 226 at content distributor 208 can receive a request for a common user interface structure from media device 102, generate the common user interface structure, and then communicate the requested common user interface structure to media device 102 for display as the common user interface structure 100.

In an implementation, media device 102 can communicate a dimension control variable for the size of display screen 130 to the content distributor 208 when the request for the common user interface structure 100 is initiated. For example, media device 102 can communicate the display height variable “y” (FIG. 1 at 114) and/or the display width variable “x” (FIG. 1 at 116), either of which can be referenced as a dimension control variable from which the other proportional geometry variables can be derived. In another embodiment, the common user interface system 226 can be implemented to generate several of the common user interface structures 222 based on different display height variables and/or display width variables such that each of the common user interface structures 222 are scaled for different display screen dimensions, and maintained for distribution until a request from a media device is received.

In this example system 200, content distributor 208 also includes storage media 228 to store or maintain the media content 220, the common user interface structures 222, and/or the user interface data 224. In addition, a content distributor 208 can be implemented with any number and combination of differing components as further described with reference to the example device shown in FIG. 5 when the device is implemented as a content distributor.

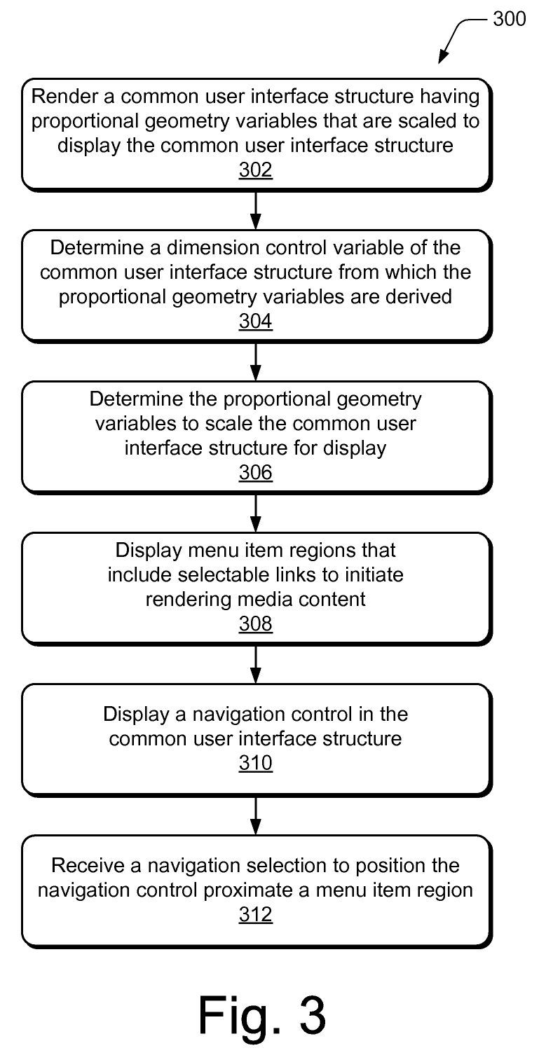

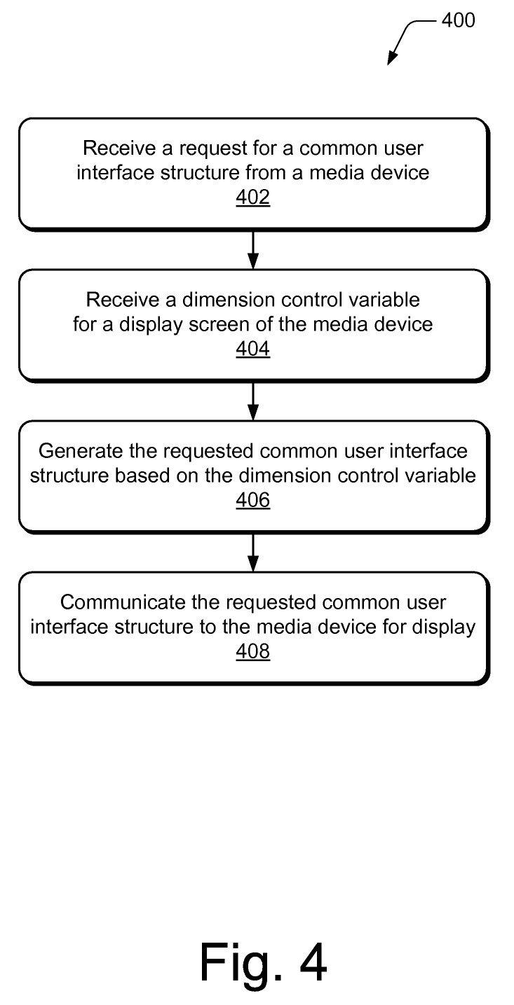

Generally, any of the functions, methods, procedures, and modules described herein can be implemented using hardware, software, firmware (e.g., fixed logic circuitry), manual processing, or any combination thereof. A software implementation of a function, method, procedure, component, or module represents program code that performs specified tasks when executed on a computing-based processor. Example methods 300 and 400 described with reference to respective FIGS. 3 and 4 may be described in the general context of computer-executable instructions. Generally, computer-executable instructions can include applications, routines, programs, objects, components, data structures, procedures, modules, functions, and the like that perform particular functions or implement abstract data types.

The method(s) may also be practiced in a distributed computing environment where functions are performed by remote processing devices that are linked through a communications network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of a common user interface structure. The order in which the method is described is not intended to be construed as a limitation, and any number of the described method blocks can be combined in any order to implement the method, or an alternate method.

At block 302, a common user interface structure is rendered having proportional geometry variables that are scaled to display the common user interface structure on media devices that each have different sized display screens. For example, any of the media devices 102 (FIG. 1) that each have different sized display screens render the common user interface structure 100 which has proportional geometry variables that can be adjusted to scale the common user interface structure 100 for display on any of the media devices 102. In an embodiment, the proportional geometry variables include a display height variable “y” at 114, a display width variable “x” at 116, a region height variable “n” at 120, a boundary region height at 124, and a navigation control region width variable of “n” at 128.

At block 304, a dimension control variable of the common user interface structure is determined from which the proportional geometry variables are derived. For example, media device 104 determines the dimension control variable as a display height of the media device display screen 130. In this embodiment, the display height variable “y” at 114 is determined as the dimension control variable from which the other proportional geometry variables are derived. Alternatively, media device 104 determines the dimension control variable as a display width of the media device display screen 130. In this alternate embodiment, the display width variable “x” at 116 is determined as the dimension control variable from which the other proportional geometry variables are derived. In another embodiment, the media device 104 communicates the dimension control variable(s) to a content distributor 208 that generates the common user interface structure 100 to scale for media device display screen 130, and the media device 104 receives the common user interface structure 100 from the content distributor 208.

At block 306, the proportional geometry variables are determined to scale the common user interface structure for display. For example, the media device 104 derives the proportional geometry variables based on the display height variable “y” at 114 (e.g., the dimension control variable in one embodiment) to scale the common user interface structure 100 for display on the media device display screen 130. Determining the proportional geometry variables of the common user interface structure based on the display height includes: determining the display width variable “x” at 116 which is defined as three-fourths of the display height; determining the region height variable “n” at 120 of the menu item regions defined as one-eighth of the display height; determining the boundary region height variable for the boundary regions 124 which is defined as one-half of the region height variable; and determining the navigation region width variable “n” at 128 for the navigation control region 126 of the common user interface structure 100.

In another example, the media device 104 derives the proportional geometry variables based on the display width variable “x” at 116 (e.g., the dimension control variable in one embodiment) to scale the common user interface structure 100 for display on the media device display screen 130. Determining the proportional geometry variables of the common user interface structure based on the display width includes: determining the display height variable “y” at 114 which is defined as four-thirds of the display width; determining a region height variable “n” at 120 of the menu item regions defined as one-eighth of the display height variable; determining the boundary region height variable for the boundary regions 124 which is defined as one-half of the region height variable; and determining the navigation region width variable “n” at 128 for the navigation control region 126 of the common user interface structure 100.

At block 308, menu item regions are displayed to include selectable content links to initiate rendering media content, the menu item regions being sized for display in the common user interface structure when the proportional geometry variables are scaled. For example, the menu item regions 118(1-7) each have a region height variable “n” at 120 which is defined as one-eighth of the display height variable “y”. Any of the menu item regions 118 can be implemented to display any type of text, images, graphics, and/or data as user-selectable content links 122.

At block 310, a navigation control is displayed in the common user interface structure, and at block 312, a navigation selection is received to position the navigation control proximate a menu item region. The position of the navigation control proximate the menu item region indicates that a selectable content link in the menu item region can be selected to initiate rendering the media content. For example, the navigation control region 126 includes a navigation control 132 that can be selected and moved to position the navigation control 132 within a menu item region to indicate that the text, image, graphic, or data selectable content link 122 in a menu item region is selectable. A user of media device 104 can enter a navigation input, such as via a selectable control 138 to initiate navigation selection inputs.

FIG. 4 illustrates example method(s) 400 of a common user interface structure. The order in which the method is described is not intended to be construed as a limitation, and any number of the described method blocks can be combined in any order to implement the method, or an alternate method.

At block 402, a request for a common user interface structure is received from a media device. For example, the common user interface system 226 at content distributor 208 (FIG. 2) receives a request for a common user interface structure 100 from media device 102 (which is representative of media device 104).

At block 404, a dimension control variable for a display screen of the media device is received. For example, the common user interface system 226 at content distributor 208 receives a dimension control variable for the size of display screen 130. The media device can communicate the display height variable “y” (FIG. 1 at 114) and/or the display width variable “x” (FIG. 1 at 116), either of which can be referenced as a dimension control variable by the common user interface system 226 to scale the other proportional geometry variables of the common user interface structure.

At block 406, the requested common user interface structure is generated based on the dimension control variable, and at block 408, the requested common user interface structure is communicated to the media device for display. For example, the common user interface system 226 at content distributor 208 generates the requested common user interface structure based on the display height variable “y” (FIG. 1 at 114) and/or the display width variable “x” (FIG. 1 at 116) received from the media device. The content distributor 208 then communicates the requested common user interface structure to the media device 104 for display on display screen 130.

FIG. 5 illustrates various components of an example device 500 that can be implemented as any form of a computing, electronic, appliance, or other media device to implement various embodiments of a common user interface structure. For example, device 500 can be implemented as a media device and/or content distributor as shown in FIG. 1 and/or FIG. 2.

Device 500 includes one or more media content inputs 502 that may include Internet Protocol (IP) inputs over which streams of media content are received via an IP-based network. Device 500 further includes communication interface(s) 504 that can be implemented as any one or more of a serial and/or parallel interface, a wireless interface, any type of network interface, a modem, and as any other type of communication interface. A network interface provides a connection between device 500 and a communication network by which other electronic and computing devices can communicate data with device 500.

Similarly, a serial and/or parallel interface provides for data communication directly between device 500 and the other electronic or computing devices. A modem also facilitates communication with other electronic and computing devices via a conventional telephone line, a DSL connection, cable, and/or other type of connection. A wireless interface enables device 500 to receive control input commands and other data from an input device, a portable computing-based device (such as a cellular phone), or from another infrared (IR), 802.11, Bluetooth, or similar RF input device.

Device 500 also includes one or more processors 506 (e.g., any of microprocessors, controllers, and the like) which process various computer-executable instructions to control the operation of device 500, to communicate with other electronic and computing devices, and to implement embodiments of a common user interface structure. Device 500 can be implemented with computer-readable media 508 such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like.

Computer-readable media 508 provides data storage mechanisms to store media content 510, as well as device applications 512 and any other types of information and/or data related to operational aspects of device 500. For example, an operating system 514 can be maintained as a computer application with the computer-readable media 508 and executed on processor(s) 506. The device applications 512 can include a device manager 516, a user interface application 518, and/or a media application 520. The device applications 512 are shown as software modules in this example to implement various embodiments of a common user interface structure. The media application 520 can be implemented as a media control application to control the playback and rendering of media content 510 and/or any other audio, video, and/or image media content which can be rendered and/or displayed for viewing.

Device 500 also includes an audio and/or video output 522 that provides audio and/or video data to an audio rendering and/or display system 524. The audio rendering and/or display system 524 can include any devices that process, display, and/or otherwise render audio, video, and image data. Video signals and audio signals can be communicated from device 500 to a display device via an RF (radio frequency) link, S-video link, composite video link, component video link, DVI (digital video interface), analog audio connection, or other similar communication link. Alternatively, the audio rendering and/or display system 524 can be implemented as integrated components of the example device 500.

Although embodiments of a common user interface structure have been described in language specific to features and/or methods, it is to be understood that the subject of the appended claims is not necessarily limited to the specific features or methods described. Rather, the specific features and methods are disclosed as example implementations of a common user interface structure.

1. A method, comprising:
rendering a common user interface structure having proportional geometry variables that are scaled to display the common user interface structure on media devices that each have different sized display screens;
determining a dimension control variable of the common user interface structure from which the proportional geometry variables are derived;
determining the proportional geometry variables to scale the common user interface structure for display; and
displaying menu item regions that include selectable content links to initiate rendering media content, the menu item regions being sized for display in the common user interface structure when the proportional geometry variables are scaled.

2. A method as recited in claim 1, further comprising displaying a navigation control in the common user interface structure, and receiving a navigation selection to position the navigation control proximate a menu item region to indicate that a selectable content link in the menu item region can be selected to initiate rendering the media content.

3. A method as recited in claim 1, wherein the dimension control variable is determined as a display height of a media device display screen, and wherein the proportional geometry variables are derived based on the display height to scale the common user interface structure for display on the media device display screen.

4. A method as recited in claim 3, wherein determining the proportional geometry variables includes:
determining a display width variable of the common user interface structure defined as three-fourths of the display height;
determining a region height variable of the menu item regions defined as one-eighth of the display height;
determining a boundary region height variable for boundary regions of the common user interface structure, the boundary region height variable defined as one-half of the region height variable; and
determining a navigation region width variable for a navigation control region of the common user interface structure, the navigation region width variable defined as the region height variable.

5. A method as recited in claim 1, wherein the dimension control variable is determined as a display width of a media device display screen, and wherein the proportional geometry variables are derived based on the display width to scale the common user interface structure for display on the media device display screen.

6. A method as recited in claim 5, wherein determining the proportional geometry variables includes:
determining a display height variable of the common user interface structure defined as four-thirds of the display width;
determining a region height variable of the menu item regions defined as one-eighth of the display height variable;
determining a boundary region height variable for boundary regions of the common user interface structure, the boundary region height variable defined as one-half of the region height variable; and
determining a navigation region width variable for a navigation control region of the common user interface structure, the navigation region width variable defined as the region height variable.

7. A method as recited in claim 1, further comprising communicating the dimension control variable to a content distributor that generates the common user interface structure to scale for a media device, and receiving the common user interface structure from the content distributor.

8. A common user interface structure, comprising:
proportional geometry variables configured to be adjusted such that the common user interface structure can be scaled for display on media devices that each have different sized display screens;
a dimension control variable of the common user interface structure from which the proportional geometry variables are derived to scale the common user interface structure for display; and
menu item regions that include selectable content links to initiate rendering media content, the menu item regions configured to be scaled for display in the common user interface structure when the proportional geometry variables are adjusted.

9. A common user interface structure as recited in claim 8, further comprising a navigation control configured for user selection to position the navigation control proximate a menu item region to indicate that a selectable content link in the menu item region can be selected to initiate rendering the media content.

10. A common user interface structure as recited in claim 8, wherein the dimension control variable is a display height of a media device display screen, and wherein the proportional geometry variables are configured to be adjusted based on the display height such that the common user interface structure is scaled for display on the media device display screen.

11. A common user interface structure as recited in claim 10, wherein the proportional geometry variables include:
a display width variable of the common user interface structure defined as three-fourths of the display height;
a region height variable of the menu item regions defined as one-eighth of the display height;
a boundary region height variable for boundary regions of the common user interface structure, the boundary region height variable defined as one-half of the region height variable; and
a navigation region width variable for a navigation control region of the common user interface structure, the navigation region width variable defined as the region height variable.

12. A common user interface structure as recited in claim 8, wherein the dimension control variable is a display width of a media device display screen, and wherein the proportional geometry variables are configured to be adjusted based on the display width such that the common user interface structure is scaled for display on the media device display screen.

13. A common user interface structure as recited in claim 12, wherein the proportional geometry variables include:
a display height variable of the common user interface structure defined as four-thirds of the display width;
a region height variable of the menu item regions defined as one-eighth of the display height variable;
a boundary region height variable for boundary regions of the common user interface structure, the boundary region height variable defined as one-half of the region height variable; and
a navigation region width variable for a navigation control region of the common user interface structure, the navigation region width variable defined as the region height variable.

14. One or more computer-readable media comprising computer-executable instructions that, when executed, direct a media device to:
render a common user interface structure having proportional geometry variables that are scaled to display the common user interface structure on a display screen of the media device;
determine a dimension control variable of the common user interface structure from which the proportional geometry variables are derived; and
determine the proportional geometry variables to scale the common user interface structure for display on the display screen.

15. One or more computer-readable media as recited in claim 14, further comprising computer-executable instructions that, when executed, direct the media device to render menu item regions for display in the common user interface structure, the menu item regions including selectable content links to initiate rendering media content, and the menu item regions being sized for display when the proportional geometry variables are scaled.

16. One or more computer-readable media as recited in claim 14, further comprising computer-executable instructions that, when executed, direct the media device to determine the dimension control variable as a display height of the display screen, and wherein the proportional geometry variables are derived from the display height to scale the common user interface structure for display on the display screen.

17. One or more computer-readable media as recited in claim 16, further comprising computer-executable instructions that, when executed, direct the media device to determine the proportional geometry variables that include:
a display width variable of the common user interface structure defined as three-fourths of the display height;
a region height variable of the menu item regions defined as one-eighth of the display height;
a boundary region height variable for boundary regions of the common user interface structure, the boundary region height variable defined as one-half of the region height variable; and
a navigation region width variable for a navigation control region of the common user interface structure, the navigation region width variable defined as the region height variable.

18. One or more computer-readable media as recited in claim 14, further comprising computer-executable instructions that, when executed, direct the media device to determine the dimension control variable as a display width of the display screen, and wherein the proportional geometry variables are derived from the display width to scale the common user interface structure for display on the display screen.

19. One or more computer-readable media as recited in claim 18, further comprising computer-executable instructions that, when executed, direct the media device to determine the proportional geometry variables that include:
a display height variable of the common user interface structure defined as four-thirds of the display width;
a region height variable of the menu item regions defined as one-eighth of the display height variable;
a boundary region height variable for boundary regions of the common user interface structure, the boundary region height variable defined as one-half of the region height variable; and
a navigation region width variable for a navigation control region of the common user interface structure, the navigation region width variable defined as the region height variable.

20. One or more computer-readable media as recited in claim 14, further comprising computer-executable instructions that, when executed, direct the media device to communicate the dimension control variable to a content distributor that generates the common user interface structure to scale for the display screen of the media device, and receive the common user interface structure from the content distributor.
